(19) United States
(12) Patent Application Publication
(10) Pub. No.: US 2017/0124649 A1
(43) Pub. Date: May 4, 2017

(54) TECHNIQUES FOR REAL-TIME ORDER PRIORITIZATION AND MATCHING

(71) Applicants: Stephen R. Schonberg, London (GB); John E. Schoen, London (GB)

(72) Inventors: Stephen R. Schonberg, London (GB); John E. Schoen, London (GB)

(21) Appl. No.: 15/339,508

(22) Filed: Oct. 31, 2016

Related U.S. Application Data
(60) Provisional application No. 62/248,113, filed on Oct. 29, 2015.

(51) Int. Cl. G06Q 40/04

(52) U.S. Cl. CPC G06Q 40/04

(57) ABSTRACT

Various embodiments are generally directed to techniques for order prioritization and matching. Techniques described herein may include one or more computing devices to receive one or more orders at a server, the one or more orders comprising orders to buy or sell currency and including an order size and a minimum time to live (MTTL). The one or more orders may be organized into buckets based upon respective order sizes and MTTLs. The one or more orders may be prioritized primarily based upon an order size and secondarily based upon MTTL. The one or more orders may be matched based upon determined priority to create a matched trade. An initial rate may be assigned to the matched trade at a first time. A final rate to the matched trade may be determined at a second time, the final rate comprising an average of a plurality of samples taken between the first time and the second time. The final rate may be assigned to the matched trade. Other embodiments are described.

### RELATED APPLICATIONS

This application claims the benefit of priority under 35 U.S.C. §119(e) to U.S. Provisional Application No. 62/248,113, entitled “Techniques for Real-Time Order Prioritization and Matching,” filed Oct. 29, 2015, which is hereby incorporated by reference in its entirety.

### BACKGROUND

Global exchanges typically operate on a streaming limit order book model (CLOB). A CLOB matches orders to buy and sell in real-time and based upon a disclosed prioritization model. One example of a prioritization model is price-time priority, in which matches are prioritized first based on price and then based upon the time of order placement. Price-time prioritization incentivizes speed, since at any given price level, orders are processed in a first-in-first-out manner. However, modifications to a streaming limit order book model may offer additional incentives.

Matching prices may differ based upon the CLOB model. In a price-time priority model, customers may receive the prices stipulated within their respective orders. In a “Dark Pool” model, participants may receive a mid-rate at the moment of a match. However, in each of these examples, the matching prices may not reflect overall market conditions before and after a trade occurs.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for real-time order prioritization and matching. Techniques described herein may provide a CLOB prioritization and matching system that sorts first using order size and second using minimum time to live (MTTL). A system operating under this CLOB model incentivizes clients to post larger orders and commit to leave these orders in the market for a longer period of time.

Some embodiments describe a Weighted-Average-Mark-Out (WAMO) pricing engine, which provides a rate to parties who have been matched based upon market activity after a match is made. Rather than a standard CLOB, where participants receive the respective rates stipulated in their orders, or in a standard “Dark Pool,” where participants receive a mid-rate at the moment of match, the WAMO pricing engine determines the economics of the match based upon the path the market takes immediately after the match.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system.

FIG. 2 illustrates a logic flow according to an embodiment.

FIG. 3 illustrates an exemplary order prioritization according to an embodiment.

FIG. 4 illustrates an exemplary volatility check according to an embodiment.

FIG. 5 illustrates an embodiment of a system.

FIG. 6 illustrates a logic flow according to an embodiment.

FIG. 7 illustrates a matrix according to an embodiment.

FIG. 8 illustrates a logic flow according to an embodiment.

FIG. 9 illustrates an exemplary order flow according to an embodiment.

FIG. 10 illustrates an exemplary order flow according to an embodiment.

FIG. 11 illustrates an exemplary order flow according to an embodiment.

FIG. 12 illustrates an exemplary order flow according to an embodiment.

FIG. 13 illustrates an exemplary order flow according to an embodiment.

FIG. 14 illustrates an exemplary order flow according to an embodiment.

FIG. 15 illustrates an exemplary order flow according to an embodiment.

FIG. 16 illustrates an exemplary order flow according to an embodiment.

FIG. 17 illustrates an exemplary order flow according to an embodiment.

FIG. 18 illustrates an exemplary order flow according to an embodiment.

FIG. 19 illustrates an embodiment of a centralized system according to an embodiment.

FIG. 20 illustrates an embodiment of a distributed system according to an embodiment.

FIG. 21 illustrates an embodiment of a computing architecture.

FIG. 22 illustrates an embodiment of a communications architecture.

### DETAILED DESCRIPTION

Various embodiments are generally directed to techniques for real-time order prioritization and matching. Techniques described herein may provide a CLOB prioritization and matching system that sorts first using order size and second using minimum time to live (MTTL). A system operating under this CLOB model incentivizes clients to post larger orders and commit to leave these orders in the market for a longer period of time.

Some embodiments describe a Weighted-Average-Mark-Out (WAMO) pricing engine, which provides a rate to parties who have been matched based upon market activity after a match is made. Rather than a standard CLOB, where participants receive the respective rates stipulated in their orders, or in a standard “Dark Pool,” where participants receive a mid-rate at the moment of match, the WAMO pricing engine may determine the economics of the match based upon the path the market takes immediately after the match.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

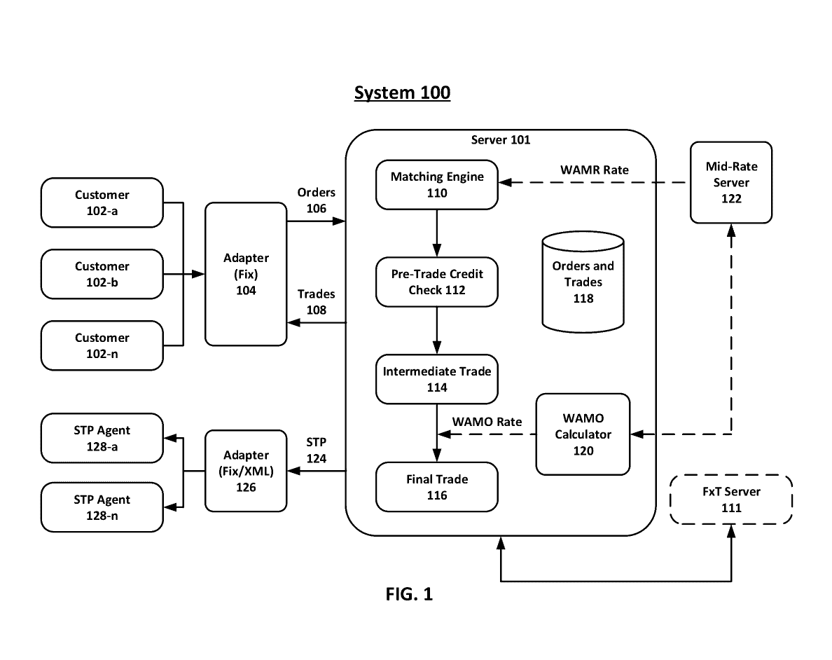

FIG. 1 illustrates a block diagram for a system 100. In one embodiment, the system 100 may comprise one or more components. Although the system 100 shown in FIG. 1 has a limited number of elements in a certain topology, it may be appreciated that the system 100 may include more or less elements in alternate topologies as desired for a given implementation. The system 100 may include a server 101, which may be generally operative to interact with one or more components or modules within system 100. Server 101 may include one or more processing units, storage units, network interfaces, or other hardware and software elements, described in more detail below.

In an embodiment, each component may comprise a device, such as a server, comprising a network-connected storage device or multiple storage devices, such as one of the storage devices described in more detail herein. In an example, customer components 102-a-n may include one or more devices used to access software or web services provided by server 101. For example, customer components 102a-n may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a wearable computing device such as a smart watch, a server, a server array or server farm, a web server, a network server, an Internet server, a work station, a mini-computer, a mainframe computer, a supercomputer, a network appliance, a web appliance, multiprocessor systems, processor-based systems, or any combination thereof.

In various embodiments, server 101 and the other components of system 100 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within system 100, and components and/or modules within a device of system 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of non-transitory signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the components and modules of the system 100 may be organized as a distributed system. A distributed system typically comprises multiple autonomous computers that communicate through a computer network. The computers interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

In an embodiment, customer components 102-a-n may include one or more computing modules associated with banks, customers, or other entities that may participate in trading positions in a market, such as the foreign exchange market. It is worthy to note that “a” and “n” and similar designators as used herein are intended to be variables representing any positive integer. Thus, for example, if an implementation sets a value for n=5, then a complete set of customers 102-n may include customers 102-1, 102-2, 102-3, 102-4, and 102-5. The embodiments are not limited in this context and it will be appreciated that in various embodiments different values of n and other designators may be used. Each customer component 102 may be configured to send one or more orders 106 for a trade of an asset, such as currency, from clients or customers. Orders 106 may be placed in a variety of ways, including through automated phone systems, websites, smartphone applications, and the like.

In an embodiment, each of orders 106 may include various fields, each with a parameter, which may comprise an order data set. By way of example and not limitation, each order may contain a client order ID, Currency (e.g., dealt currency, base), Side (e.g., buy, sell), Symbol (currency pair, e.g., EUR/USD), TransactTime (e.g., transaction timestamp), OrderQty (e.g., specified order amount), OrdType (e.g., order type, such as “M” for mid-match), Account (e.g., optional fund subsidiary ID), TimelnForce (e.g., expiration type), MidMatchTriggerRate (e.g., optional trigger rate), MinTimeToLive (e.g., minimum time to live before order can be canceled, such as S=short, M=medium, L=long, each corresponding to a predefined time period), MTTLMatchingPreference (e.g., matching preference with opposing orders, such as Match All, All Except Short, Aged Equivalent, Aged Equivalent Except Short, MTTL Equivalent, MTTL Equivalent or Aged Equivalent, MTTL Equivalent or Aged Equivalent Except Short). In some embodiments, orders may be set to match at a time of t0, rather than at a later time described by some embodiments herein. A user interface may provide an option for each order, and/or may provide default settings for orders from a customer.

Each customer component 102 may be responsible for one or more trades sent to server 101. Trades may be one or more data messages sent via an intermediary system, such as adapter 104. Adapter 104 may include a trading platform operated by a third-party, or a trading platform associated with server 101, which may provide secure access to server 101. In one example, adapter 104 may implement the Financial Information eXchange (FIX) protocol, which allows for international, real-time, exchange of information related to securities transactions and markets. However, it can be appreciated that other platforms may be used. In other embodiments, an intermediary platform may not be used. Each trade may include information indicating whether the trade is a buy or a sell, the specific currency being bought or sold, the specific amount of currency to be bought or sold, the other currency desired, the date of trade settlement, the specific benchmark rate fixing desired, and associated bank.

In an exemplary embodiment, a plurality of orders 106 may be sent from a plurality of customer components 102 to server 101, via adapter 104. Server 101 may store orders and trades in database 118. Specifically, initial orders, intermediate trades, and final trades may be stored within database 118. In one example, customer component 102-a may place an order to buy 20 million Euro at the WM/Reuters® mid-point benchmark rate. Customer component 102-b may place an order to buy 50 million Euro at the WM/Reuters® mid-point benchmark rate. Customer component 102-n may place an order to buy 20 million Euro at the WM/Reuters® mid-point benchmark rate. While specific currencies, amounts, and rates may be used for purposes of illustration, it can be appreciated that other amounts, currencies, and rates may be used in various implementations.

In some embodiments, matching engine 110 may be configured to receive orders 106 from customer components 102 at server 101, which may be sent via an adapter 104, as discussed above. Matching engine 110 may implement CLOB prioritization and matching logic, using a combination of hardware and software, to sort orders by size and then MTTL and then time, and match orders based upon priority once sorted. Each received order 106 may include data indicating the size of an order and the MTTL for the order. In addition, a time stamp may be associated with the order, either by adapter 104, server 101, or matching engine 110.

Order size may be used by matching engine 110 to sort incoming orders into buckets. In one exemplary embodiment, three buckets may be used (small, medium, large), however, it can be appreciated that more or less buckets may be used in different embodiments, which may include differing asset classes, currency pairs, and securities. In an example, an order of 1 million of base currency may be placed into a small bucket, an order of between 2-9 million of base currency may be placed into a medium bucket, and an order of 10 million or more of base currency may be placed into a large bucket. Matching engine 110 may sort orders first by bucket size. For example, a larger order placed after a small order may be placed at the beginning of a matching queue.

Orders 106 may also include an associated MTTL, indicating the minimum time to live, or in other words, the minimum amount of time an order will be pending before it can be canceled by the customer. In some embodiments, even after the MTTL has expired, an order may remain active until canceled by a customer. MTTL may be measured server-side, beginning upon receipt of the order. Like order size, buckets may be used to sort orders based upon MTTL. In an exemplary embodiment, a small bucket may be used for MTTL of 100 milliseconds or less. A medium bucket may be used for MTTL between 100 milliseconds and 2 seconds. A large bucket may be used for MTTL between 2-8 seconds, or longer. To encourage longer pendency, greater MTTL may correspond with higher priority. Thus, if two order are both placed into large buckets, and thus prioritized by matching engine 110 to be the same, the order with a greater MTTL will be prioritized higher by matching engine 100.

In addition to order size and MTTL, matching engine 110 may take into account the time at which an order is received. The time stamp for an order may be determine device-side, by adapter 104, or server-side at server 101. Thus, if two orders are both large in size, and have large MTTL, the order received first may be prioritized higher by matching engine 110.

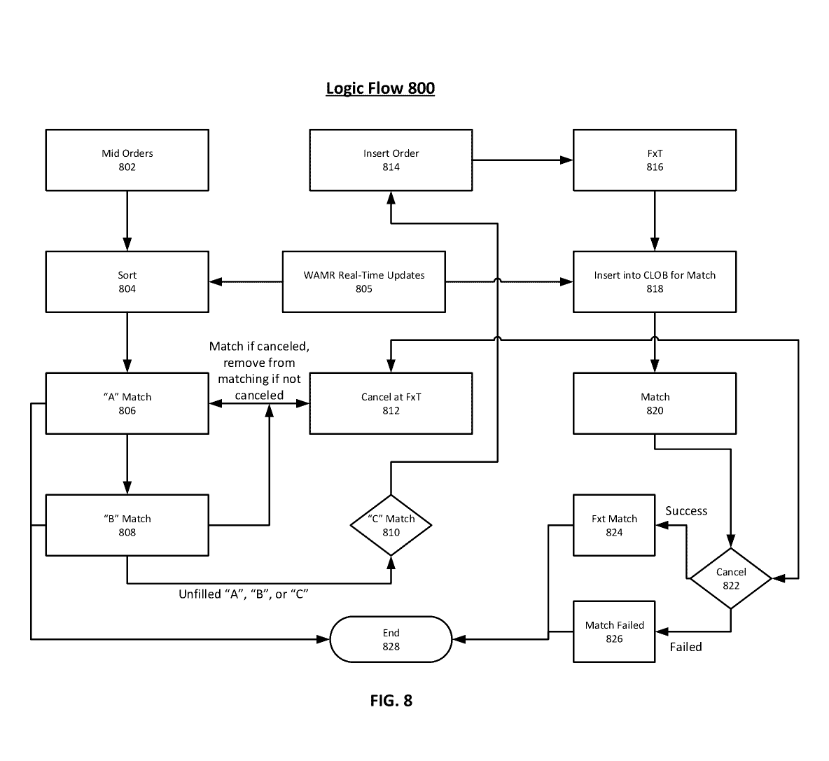

In some embodiments, an additional FxTrades (or other foreign exchange or other trading platform) server 111 may be present within system 100. These additional servers may be external to server 101, or the functions of additional servers may, in some embodiments, be internal to server 101. FxTrades Server 111 may provide a separate pool of matching customers for which a customer of server 101 may be matched with and may include an independent matching engine. Thus, in some embodiments, a user interface may be provided on a client device that allows a customer to enter an order in one or more servers in addition to server 101. The additional servers may provide increased liquidity and matching opportunities for a customer. If a client flags an order as “available for matching with FXTrades liquidity”, for example, the order may be concurrently posted to server 101 and as an invisible GTC limit order within the FXTrades server 111, and pegged to each subsequent WAMR update (subject to the client expressed trigger rate as worst case bound). Any executions in either server may be done at the posted or next polled WAMR rate and may reduce the balance of the order in the other pool via OCO functionality to avoid double fills. As with orders placed within server 101, as described herein, the client may be able to express a trigger rate (i.e. the price at which, or better, they are willing to match) in additional servers, such as FxTrades server 111. The matching process used for additional servers is described in more detail with respect to FIG. 8.

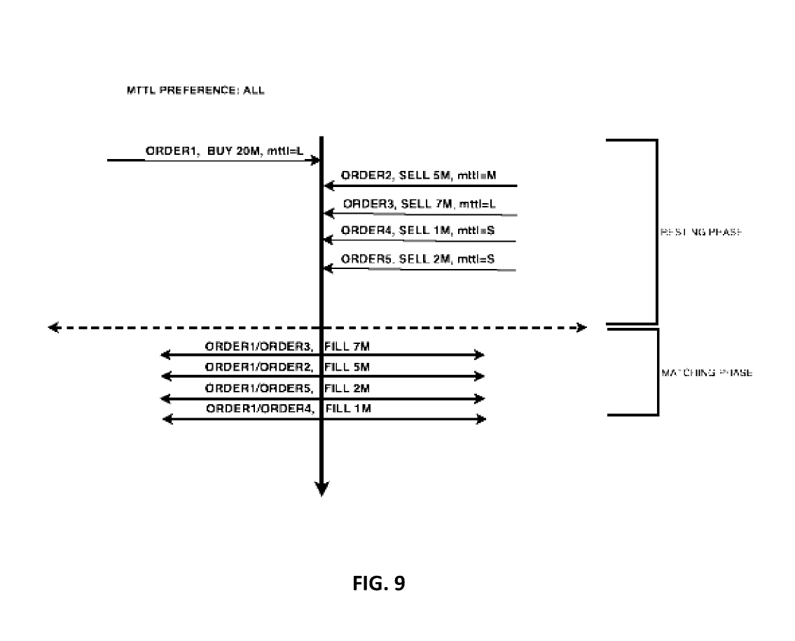

In exemplary embodiments, matching engine 110 may take into account one or more optional preferences for order matching, received within the data of orders 106. For example, when placing an order, a customer may have one or more options for order matching, which will then be communicated from a customer component 102 to server 101 via adapter 104. These options may include, but are not limited to: All; MTTL Equivalent; MTTL Equivalent, Except Short; Aged Equivalent; Aged Equivalent, Except Short; MTTL Equivalent or Aged Equivalent; MTTL Equivalent or Aged Equivalent, Except Short. As mentioned above, customers may opt to match orders at a time t0 in some embodiments. Using these options, which may be entered using a user interface of a trading platform on customer components 102, customers may limit the potential matches for orders. Each of these options is illustrated and described in more detail below, with respect to FIGS. 9-15.

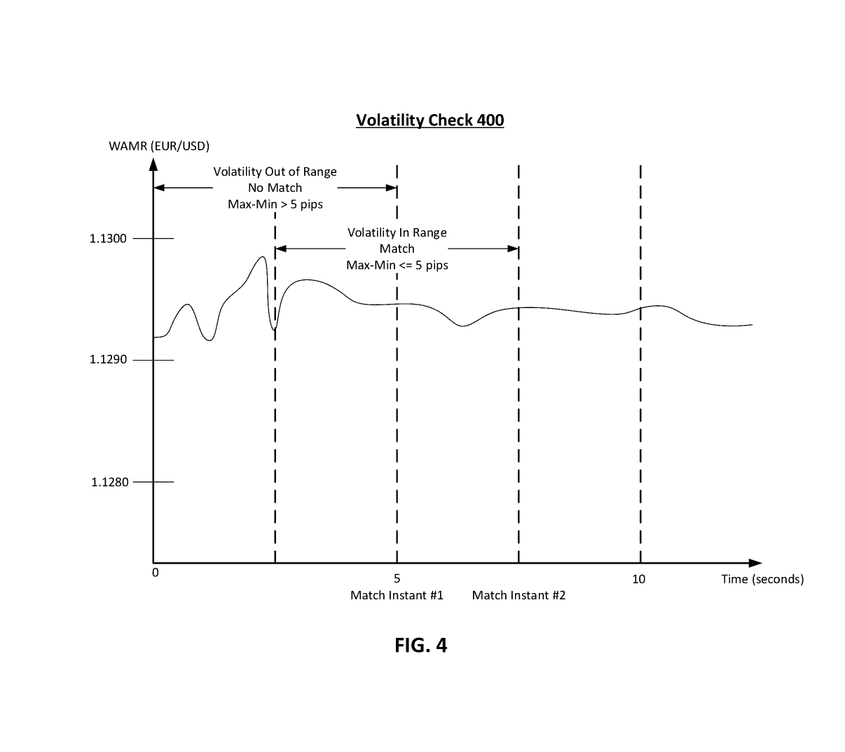

In an embodiment, matching engine 110 may perform conditional volatility matching. Based upon instrument-specific rules, matching engine 110 may prevent matching during time period of intense volatility, unless orders have explicitly opted out of this protection. Thus, if matching engine 110 determines that current market conditions are volatile, matches will not be made for orders unless they have opted out of conditional volatility matching protection. In one example, a market may be volatile when a weighted average mid-rate (WAMR) range within a previous rolling “x” seconds is greater than “y” percent of current WAMR (expressed in pip spread). Of course, volatility for certain markets may vary based upon historic volatility in the marker and, thus, matching engine 110 may determine a market to be volatile based upon various criteria. An illustration and further description of conditional volatility matching is set forth below with respect to FIG. 4.

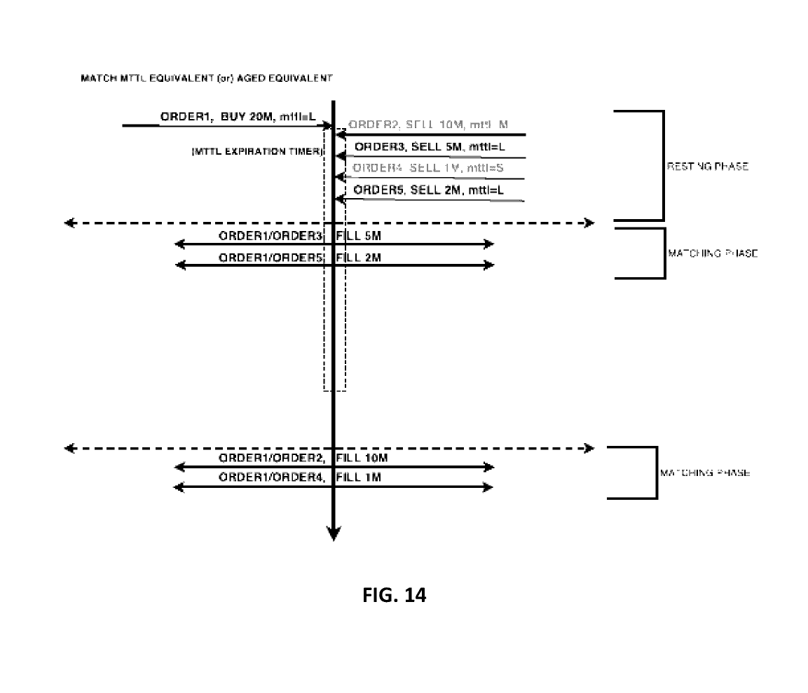

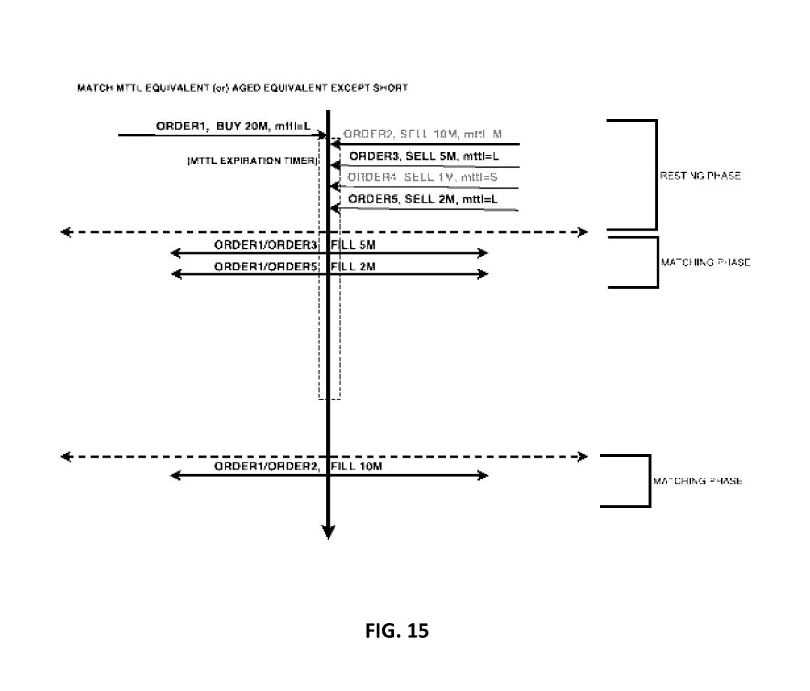

In some embodiments, matching engine 110 may implement self-matching. If a single client inserts orders on both sides of the market (e.g. both buy and sell orders), matching engine 110 may be configured to detect such activity, which is undesirable, and ignore the prioritization discussed above. In this manner, matching engine 110 may immediately match a single client's buy and sell orders, ignoring other prioritization logic. In some embodiments, self-matching may not be permitted within the MTTL timer of either order and, in such cases, matching engine 110 may reject the second received order. Illustrations and further description of self-matching may be found below with respect to FIGS. 14 and 15.

In exemplary embodiments, orders may include a t0 limit price, such that the order will only be available for matching at t0 if the prevailing weighted average mid-rate (WAMR) is at, or better, than their limit price at the moment of match. Mid-rate server 122 may provide a WAMR rate to matching engine 110. A WAMR rate may be automatically and continually calculated and polled randomly (e.g., every 0-100 ms) by mid-rate server 122. In some embodiments, the WAMR rate may be determined based upon one or more prices received over networked pricing streams. These networked pricing streams may be periodically or continuously received by mid-rate server 122 and each pricing stream may be weighted.

Once matching engine 110 has sorted, prioritized, and matched orders as discussed above, a pre-trade credit check component 112 is performed for each trade. Pre-trade credit check 112 may be performed using known credit-check systems and techniques, and may be used to verify the credit of each party to a transaction and reserve adequate credit to place an order. Pre-credit check component 112 may be configured to extract credit information, such as name and tax identification number, from an order and perform a credit check using such information. Once a pre-trade credit check has been completed, and parties to the transaction are verified to have adequate credit, an intermediate trade 114 is created. Upon creation of intermediate trade 114, customer components 102 may be notified via adapter 104 of the matched trade and a t0 initial match rate, which may be received from mid-rate server 122. The t0 initial match rate may be determined by referencing an appropriate market data stream, such as a WAMR rate from mid-rate server 122, at a randomized interval (e.g. 0-100 ms) after a match has been made. In some embodiments, customers may opt to trade at the t0 initial match rate, which means a final trade is performed at that time. Some or all of the intermediate steps discussed below may be skipped if a customer opts to trade at the t0 initial match rate.

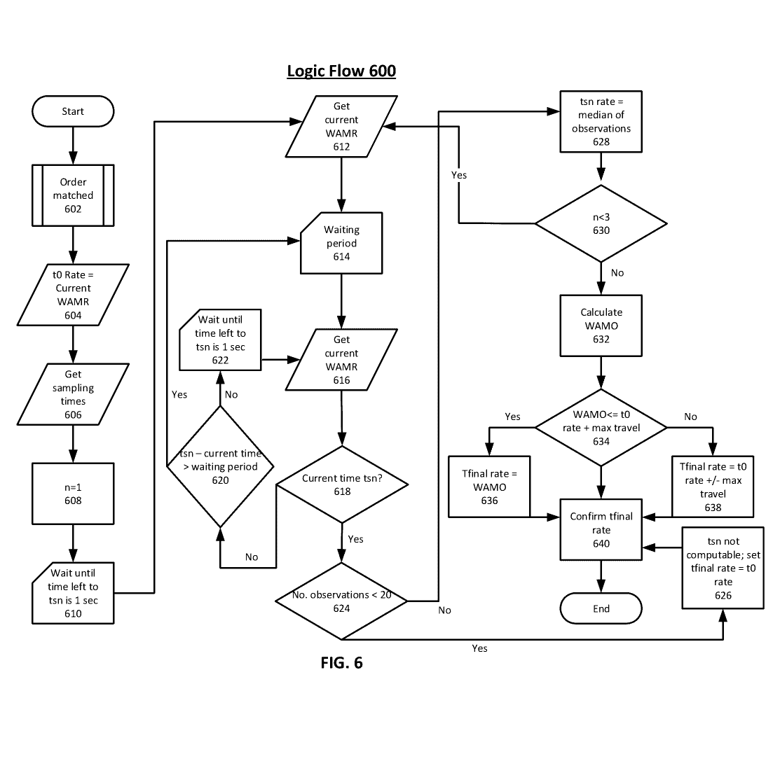

In some embodiments, a weighted-average mark-out (WAMO) calculator engine 120 may be configured to determine a final match rate that takes into account market conditions during a predetermined time period after a match has been made. In some embodiments, the time period may be 20 seconds, however, it can be appreciated that shorter or longer time periods may be used. The WAMO rate may be calculated based upon a median of WAMR observations in the lead up to a number of time periods, such as t10, t15, t20 (10 seconds, 15 seconds, and 20 seconds after a match t0). In this manner, there may be sufficient time for alpha decay post t0 mid-match, without using an IOU model. In some embodiments, the WAMO rate may be an average of WAMR at each of three time horizons (t10/33%, t15/33%, and t20/34%, in one exemplary embodiment). The final match rate may be used to establish final trade 116, which may be reported to customer components 102 via adapter 104 and straight through processing (STP) agents 128 via adapter 126. An exemplary algorithm for determined a final match rate by WAMO calculator engine 120 is illustrated and described with respect to FIG. 6 below.

In addition to reporting a final match rate, periodic reports may be produced by one or more components described herein and sent to customers or others. For example, information compiled on performance statistics of MidX and for individual client activity (e.g., participants, orders, matches, volume traded, pairs, average lifetime of orders, average bro per 1M, markout-profiles, or other information) may be included within such reports. In addition, order profiles of counterparties may be determined and compiled into reports. For example, statistics such as 1M/5 ms TTL (22%), 2-9M/5 sec TTL (17%) may be compiled and reported. Still further, information regarding canceled orders may be reported and used to provide insight into missed matching opportunities.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer). For example, a logic flow may be implemented by a processor component executing instructions stored on an article of manufacture, such as a storage medium or a computer-program product. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

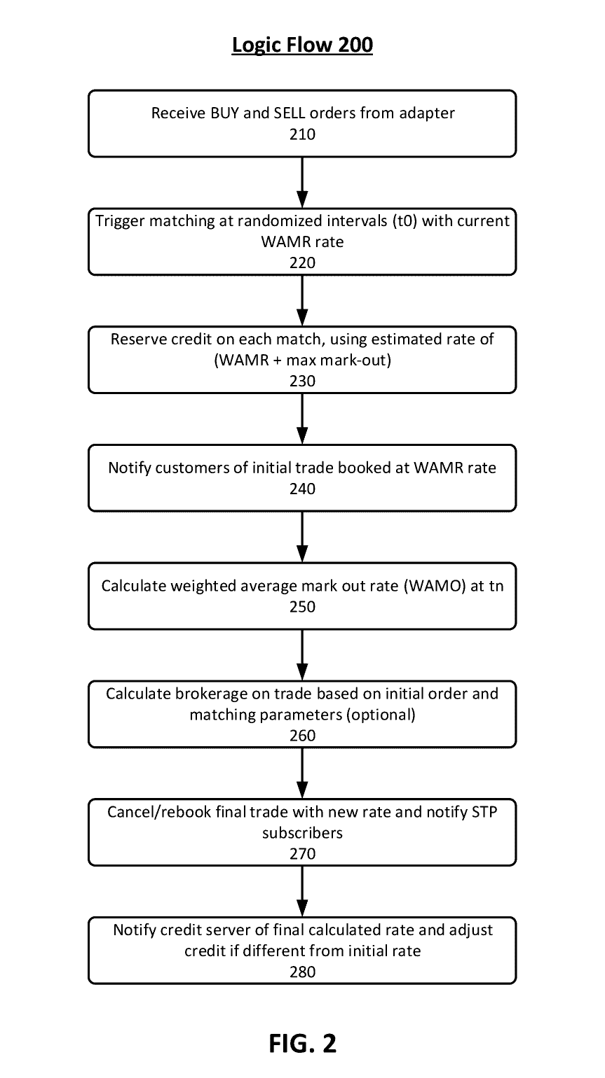

FIG. 2 illustrates one embodiment of a logic flow 200. The logic flow 200 may be representative of some or all of the operations executed by one or more embodiments described herein. For instance, the logic flow 200 may be representative of some or all of the operations executed by system 100 or 500, and the components and modules included therein.

At 210, one or more buy and sell orders may be received by an adapter or server. The received orders may include data indicating the size of an order, the MTTL, any options discussed herein, and identifying information. More or less information may be included in some embodiments.

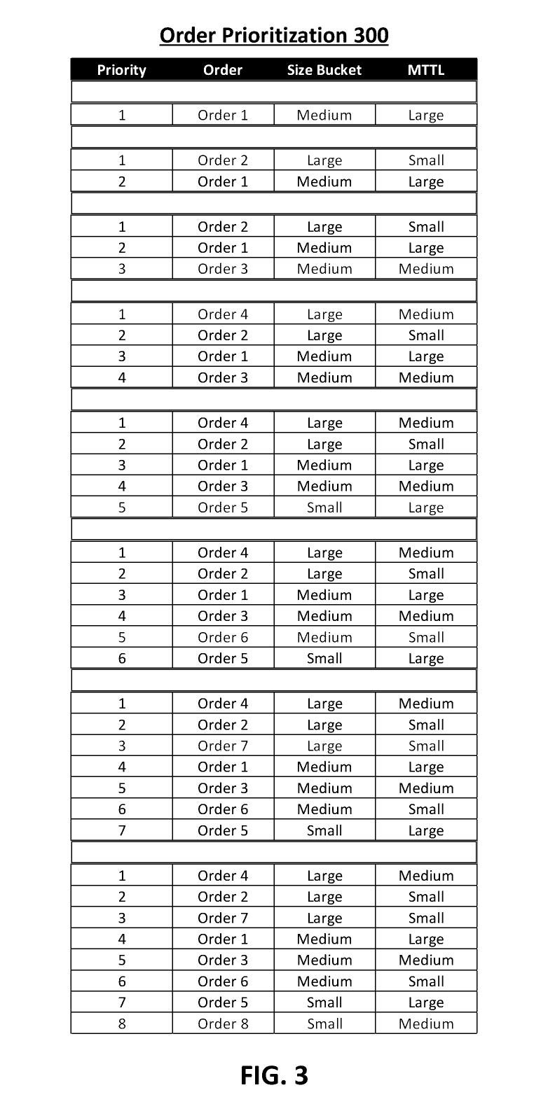

At 220, a matching engine may trigger matching at randomized intervals (t0) using a current WAMR rate, which may be received from a mid-rate server. During matching, a matching engine may use the techniques described herein for order prioritization. An exemplary order prioritization performed by a matching engine is illustrated within FIG. 3.

At 230, for each match, credit may be reserved using one or more credit servers for each party to the trade. Credit may be reserved based upon a current WAMR rate plus a maximum mark out. In this manner, credit may be reserved based upon maximum credit exposure and the potential for matching failure after calculation of a final rate may be avoided. Once credit has been reserved and an initial rate is set to current WAMR, customers may be notified that an initial trade has been booked at 240.

As described above, some embodiments may implement a WAMO pricing methodology, in which a final rate may be determined using a time period after a match has been made. At 250, at time tn, a WAMO rate may be calculated according to the algorithm described herein. At 260, brokerage fees may be calculated based upon the initial order and matching parameters. At 270, the initial trade may be canceled and replaced with a rebooked final trade at the final rate calculated above. The final trade may be communicated to STP subscribers at 280 and, in some embodiments, a credit rate may be adjusted if different than the initial rate.

FIG. 3 illustrates an exemplary order prioritization according to an embodiment. Although the example uses specific values, it can be appreciated that the specific values described herein are used for illustrative purposes only and should not be limiting in any way. Order prioritization 300 illustrates the prioritization of eight orders by a matching engine, as described above. Orders may be prioritized based upon size, then MTTL, and then time. In this manner, there are incentives to place larger orders that have longer MTTL.

In the exemplary embodiment, three size buckets may be used (small, medium, large), however, it can be appreciated that more or less buckets may be used in different embodiments, which may include differing asset classes, currency pairs, and securities. In the example, an order of 1 million of base currency may be placed into a small bucket, an order of between 2-9 million of base currency may be placed into a medium bucket, and an order of 10 million or more of base currency may be placed into a large bucket.

Orders may also include an associated MTTL. MTTL may be measured server-side, beginning upon receipt of the order. Like order size, buckets may be used to sort orders based upon MTTL. In some embodiments, MTTL may be chosen based upon predefined values and characterized accordingly. For example, MTTL values of Short, Medium, and Long may be predefined and chosen. A value may be associated with each MTTL value, such as 100 milliseconds for Short, 2 seconds for Medium, and 8 seconds for Long. However, in some embodiments, any value may be chosen and MTTL may be subsequently sorted into buckets. In the exemplary embodiment, a small bucket may be used for MTTL of 100 milliseconds or less. A medium bucket may be used for MTTL between 100 milliseconds and 2 seconds. A large bucket may be used for MTTL between 2-8 seconds, or longer. As used herein, small and large may correspond to short and long, respectively.

As can be seen within FIG. 3, Order 1 of 2M is placed into a Medium size bucket and a Large MTTL bucket. Order 2, despite being placed after Order 1, is placed before Order 1 due to its Large size bucket. Order 3 is placed last even though it has the same size bucket as Order 2. Order 3 is prioritized lower than Order 2 because the second prioritization criteria, MTTL, is Medium for Order 3 and Large for Order 2. In this manner, larger order sizes will be prioritized first, and orders with common size buckets will be prioritized based upon MTTL. As shown by Order 7 being placed behind Order 2 despite having the same size bucket and MTTL bucket, a matching engine will use order time as a tie-breaker.

FIG. 4 illustrates a volatility check 400 according to an embodiment. As described above, a matching engine may perform conditional volatility matching. Based upon instrument-specific rules, a matching engine may prevent matching during time period of intense volatility, unless orders have explicitly opted out of this protection. Thus, if a matching engine determines that current market conditions are volatile, matches will not be made for orders unless they have opted out of conditional volatility matching protection. In one example, a market may be volatile when a weighted average mid-rate (WAMR) range within a previous rolling “x” seconds is greater than “y” percent of current WAMR (expressed in pip spread). Of course, volatility for certain markets may vary based upon historic volatility in the marker and, thus, a matching engine may determine a market to be volatile based upon various criteria. The example shown in FIG. 4 illustrates a volatile period from 0-5 seconds in which no matches are made. Once volatility is detected to be in range, during the time period between 2.5-5 seconds, two matches are made.

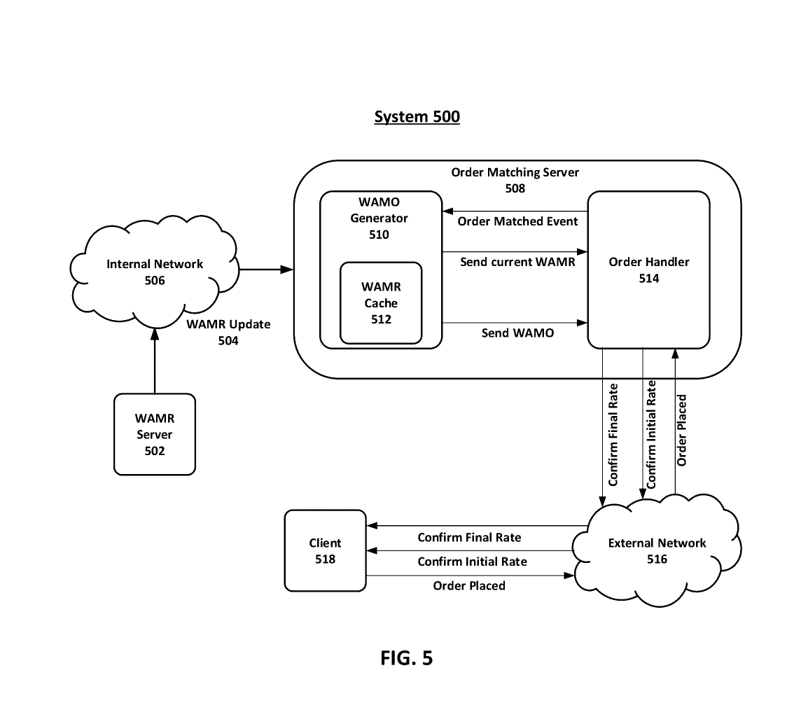

FIG. 5 illustrates exemplary system 500, which may be used to match orders and determined a WAMO price after matches are made. A WAMR server 502 may send a WAMR update 504 to order matching server 508 via internal network 506. Although an internal network is illustrated, it can be appreciated that an external network may be used in some embodiments. Order matching server 508 may receive WAMR updates automatically and/or periodically, and store the data within WAMR cache 512, which may include one or more non-transitory computer-readable storage media. WAMO generator 510 may use cached WAMR data to determine a WAMO rate for matched trades, and to provide current WAMR rates to order handler 514, as discussed below.

A client 518 may place an order, which may be routed through external network 516 to order handler 514 of order matching server 508. While an external network is illustrated, it can be appreciated that an internal network may be used in some embodiments. Order handler 514 may perform order prioritization and matching consistent with the order prioritization and matching techniques described herein. Once a match has been made, a current WAMR rate may be received from WAMO generator 510 in response to an order matched event, which may be a data communication between order handler 514 and WAMO generator 510. A confirmation of initial rate may be sent to client 518 via external network 516. In response to an order matched event sent to WAMO generator 510, WAMA generator 510 may determine a finalized WAMO rate using the techniques described herein. Once determined, a final rate for the trade may be sent from WAMO generator 510 to order handler 514, and then to client 518.

FIG. 6 illustrates a logic flow 600 for determining a WAMO rate, according to an embodiment. The logic flow 600 may be representative of some or all of the operations executed by one or more embodiments described herein. For instance, the logic flow 600 may be representative of some or all of the operations executed by system 100 or 500, and the components and modules included therein.

At 602, an order may be matched by a matching engine, as described above. Upon receiving an indication that an order has been matched, an initial rate at t0 may be set at a current WAMR rate. As described herein, the initial rate may be used to perform credit checks, reserve credit, and notify parties to a trade that a match has been made. Over a period of time, which may be predetermined in some embodiments, a final rate may be determined at a time tn, which may be a predetermined time period after t0. In some embodiments, the time window between t0 and tn may be 20 seconds, however, it can be appreciated that shorter or longer time periods may be used in some embodiments.

At 606, sampling times may be received. A system, such as system 100 or 500, may be configured to poll rates from a reference market data sources. In some embodiments, different randomization techniques or preset time intervals may be used. In addition, filtering or smoothing of data may be used to stabilize the data used for sampling. Differing financial instruments may have different sources for reference market data, different averaging methodology, and one or more sources may be used in various embodiments. In an example, three samples may be taken and averaged at t10 (t0+10 seconds), t15, and t20. In another example, a single snapshot of market data may be used at t300 (5 minutes after the initial match). In any event, at 606, the sampling times are received such that the relevant market data may be collected at the appropriate time. In the example, sampling times 1, 2, 3 may be given, with sampling at the 10^{th}, 15^{th}, and 20^{th} seconds after t0, making ts1 being t10, ts2 being t15, and ts3 being t20. It should be noted that the system may be configured to avoid manipulation, thus, the determination of the WAMO rate as described herein may be derived only from prices and orders which exclude the counterparties to the t0 trade.

At 608, a variable n is set to 1, indicating that a first sample has been scheduled. Thus a variable in memory may be set to take a sample at time 1. At 610, a waiting period until just before time 1 is set. In an embodiment, the waiting period may be until 1 second prior to time 1. Of course, the waiting period may be less or more in some embodiments. Once the waiting period has lapsed, a sampling of the current WAMR rate is retrieved at 612. The sampling of the current WAMR rate may be retrieved from one or more servers as described herein. This process is repeated from 614 until 622 until tsn (thus operating for approximately 1 second, between ts1-1 second and ts1, in this example) is reached, with observations stored in a non-transitory computer-readable storage medium.

At 624, it is determined whether a number of observations is less than 20, however, more or less observations may be used based upon different implementations. If there are less than a fixed number of observations, the final rate may be set to the initial rate at 626, since not enough observations are available to determine an accurate WAMO rate. A low number of observations may indicate some market or systemic failure and, thus, the initial rate may be used. If the number of observations are equal or greater than some fixed number, which is 20 in this example, a tsn rate is set at 628 as the median of observations previously recorded (thus, in this example, ts1 would be set at a rate that is the median of observations taken from ts1-1 second until ts1).

At 630, it is determined whether n<3, in this example, which is determining whether three samples have been taken thus far. As set forth above, more or less samples may be chosen in different embodiments. If n<3, the process repeats for n=2 and n=3, in this example. However, if n>=3, a WAMO rate may be calculated at 632. The WAMO rate calculation may be calculated as the average of ts1, ts2, and ts2, for example. Once calculated, it is determined at 634 whether the WAMO rate is less than or equal to the initial rate plus some maximum travel. Maximum travel may be some threshold distance from the initial WAMR rate. If the WAMO rate is within the maximum travel, the final rate is set to the WAMO rate at 636. However, if the WAMO rate is greater than the maximum travel, the final rate will be set to the initial WAMR rate+/−the maximum travel amount at 638. In an example, if a t0 rate=123.45 and the maximum travel is set to 0.05, then any WAMO above 123.50 would be marked at 123.50 and any WAMO below 123.40 would be marked 123.40).

The final rate may be confirmed to customers and STP agents at 640. In some cases, the confirmed final rate may be the rate set at 636 or 638. In other cases, the final rate may be modified to include brokerage fees, in which a brokerage fee is added or subtracted from the final rate prior to confirmation. Some customers may opt-in to receive unique anonymous identifiers (UIDs). If both counterparties have opted-in, then at tn, both sides may receive UIDs such that they can monitor their own matching details versus other unique counterparties on the platform. In this manner, clients may see other transactions on the trading platform in an anonymous manner.

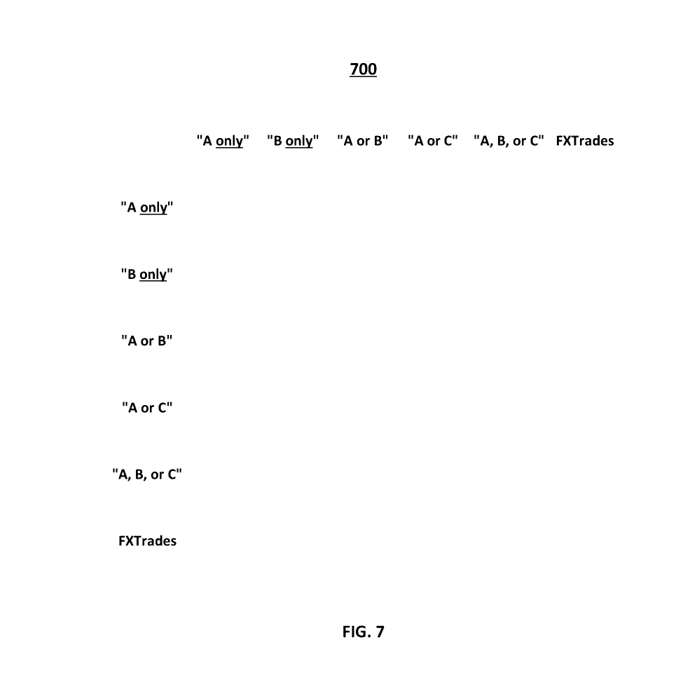

FIG. 7 illustrates a matrix according to an embodiment. Matrix 700 illustrates an exemplary embodiment of matching logic using at least three order types, A, B, and C. It can be appreciated that other order types may be present within some embodiments, but these three have been chosen for purposes of illustration. Order type “A” may represent Mid liquidity pool matching at t0 WAMR (i.e. the next WAMR update). Order type “B” may represent Mid liquidity pool matching at t20 WAMO (i.e. mark-out approach averaging t10, t15, and t20 WAMR rates, as an example). Order type “C” may represent OCO as an FXTrades hidden order pegged at t0 WAMR (i.e. match does not hit Ticker, minimum size 1M, no MTTL, etc.). In some embodiments, order type “C” may include two or more liquidity pools, which may include two or more servers and/or matching engines. In some embodiments, multiple matching engines may be present on the same server, and in other embodiments, matching engines and servers may be placed in a distributed environment.

As illustrated, a Mid order may be inserted with one of five matching preferences. In order to maximize matching opportunities, a client may configure an order to match at t0 rate (WAMR) or t20 rate (WAMO) and/or with FXTrades liquidity (an additional liquidity pool) at t0 WAMR rate. Orders with preference of “A only”, “B only” or “A or B” may be matched exclusively with Mid pool interest at next WAMR subject to the Mid matching rules described herein. Mid orders with a preference which includes a “C” (i.e. “A or C” or “A, B or C”) may be placed in a Mid pool and pending the next WAMR update may also exposed to matching with FX Trades liquidity as well.

FIG. 8 illustrates a logic flow 800 according to an embodiment. Matrix 700 may be described using logic flow 800 for matching orders of types A, B, and C. A orders may include A only, “A or B”, “A or C”, or “A or B or C”, for example. B orders may include B only, “A or B”, “B or C”, or “A or B or C”. Likewise, C orders may be any order including a C. At 802, Mid orders may be received at a server, such as server 101 and sorted at 804, which may be using any of the various order parameters described herein. At 806 and 808, “A” and “B” orders may be matched by polling WAMR 805, checking a trigger rate, and determining whether there are any available matches within the Mid pool. If yes, matches may be done at t0 WAMR (A) or t20 WAMO (B) using the techniques described herein. Matching may be performed using a matching engine, such as matching engine 110, described above. In some embodiments, such as with C orders, multiple matching engines present on the same server, or in a distributed system, may be used.

At 810, any order including C may be sent to another liquidity pool associated with C, such as FxTrades 816. At 818, the order may be placed into CLOB for matching, and may be subsequently matched at 820. When matched at 820, a cancel request may be made to block 812, where an order is attempted to be canceled from matching within another liquidity pool. If a cancellation is successful, a match may be made at 824. If a cancellation is a failure, a match may fail at 826. Likewise, when A and B matching is performed at 806 and 808, if a C component is within the order, a FxTrades order cancellation 812 may be required before an order is confirmed. In this manner, an order may be matched within multiple liquidity pools without creating double fills.

FIGS. 9-18 illustrate exemplary order flows consistent with the embodiments described herein. While specific values are used, it can be appreciated that these are for illustrative purposes only, and should not be construed as limiting in any way.

FIG. 9 illustrates an order flow in which a client is willing to match against any order and is indifferent to both order size and MTTL. In this manner, Order 1 is matched against all of Orders 2-5.

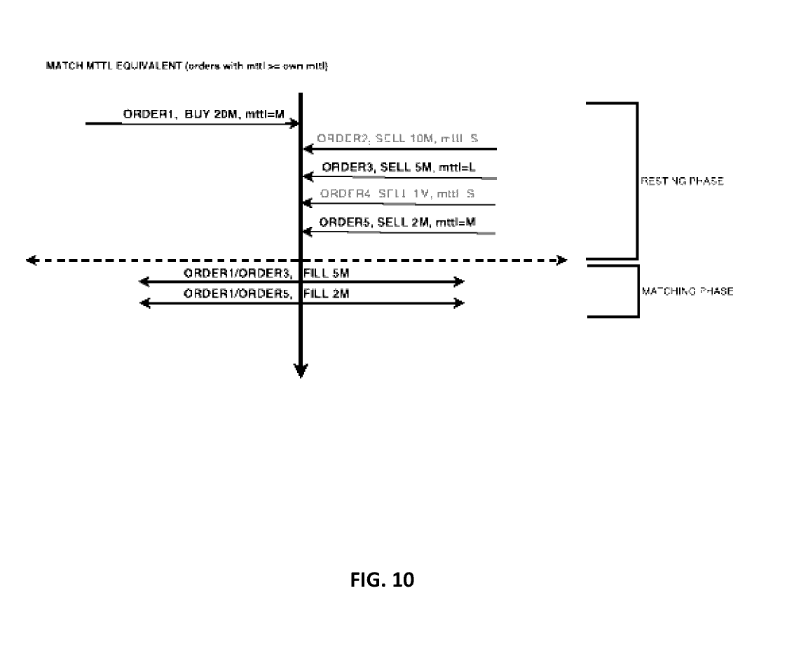

FIG. 10 illustrates an order flow in which a client is only willing to match against other orders with a MTTL that is equal to or greater than its own. In this manner, Orders 2 and 4 are excluding from matching with Order 1.

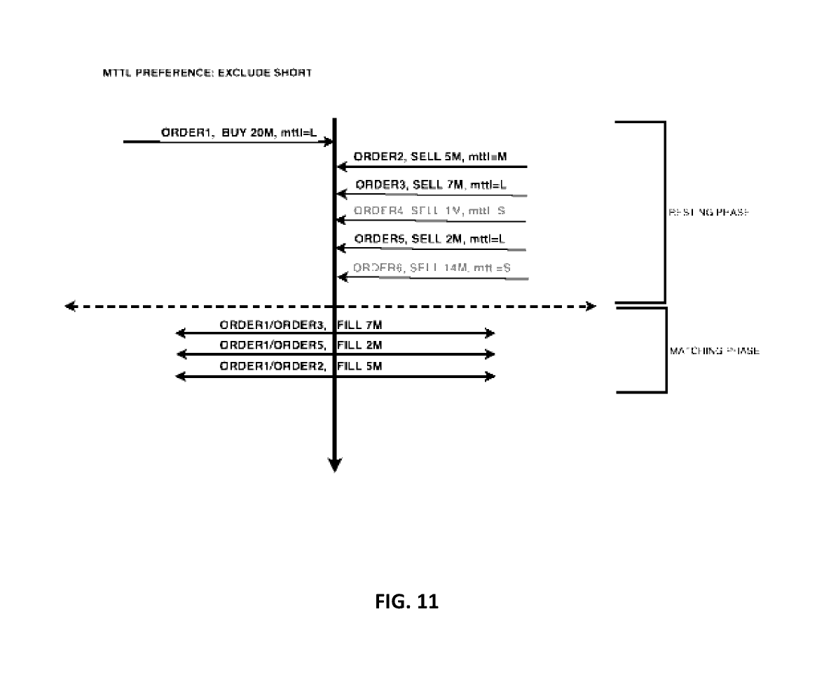

FIG. 11 illustrates an order flow in which a client is willing to match against all orders with the exception if those with very low attributes for MTTL. This option may be given to all clients except those who themselves have elected a “short” (very low) MTTL value. In this manner, Orders 4 and 6 are ineligible for matching with Order 1.

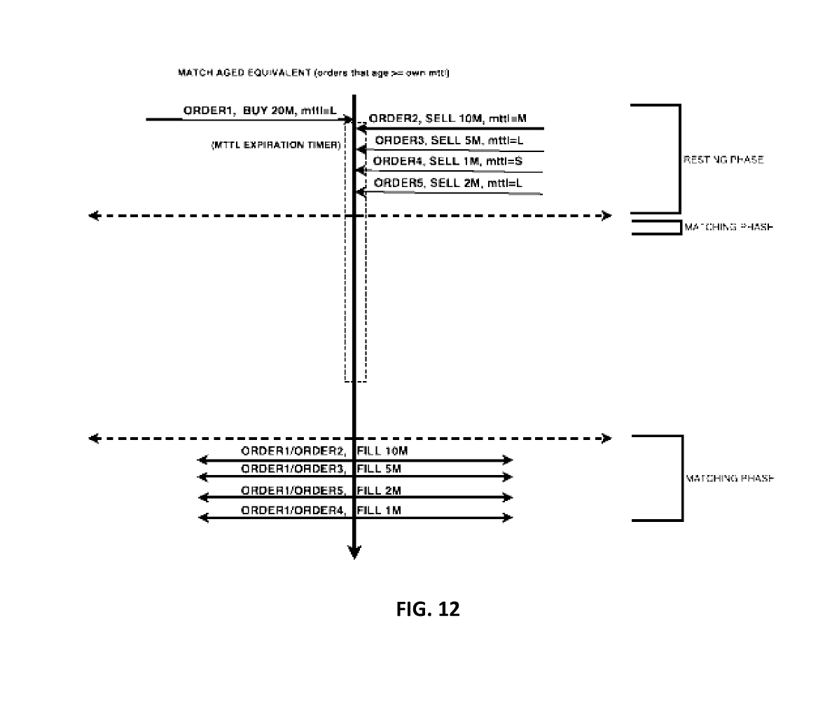

FIG. 12 illustrates an order flow in which a client is willing to match with all orders provided that the order has lived for greater than or equal to its own order. In this manner, Order 1 is not matched during the first matching phase, but upon expiration of the MTTL timer, Orders 2-5 are matched.

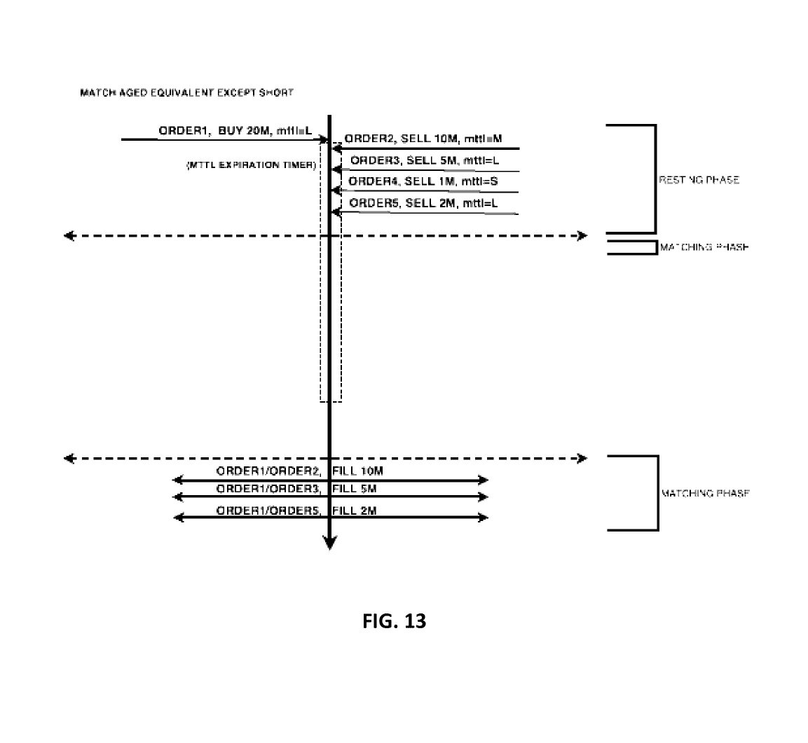

FIG. 13 illustrates an order flow in which a client is willing to match against all orders provided that the order has lived greater than or equal to its own MTTL, excluding orders designated as “short” (very low) MTTL. In this manner, upon expiration of the MTTL timer, Order 4 is excluded from matching with Order 1.

FIG. 14 illustrates an order flow in which a client is willing to match against all orders provided that the opposing order has an expressed MTTL greater than or equal to its own, or provided the opposing order has been active in the book for a period of time greater than or equal to its MTTL. In this manner, an order with a Large MTTL of 8 seconds may be aggressed on by a Small/Short MTTL order after the Small/Short MTTL order has been in the book for 8 seconds.

FIG. 15 illustrates an order flow in which a client is willing to match against all orders provided that the opposing order has an expressed MTTL greater than or equal to its own, or provided the opposing order has been active in the book for a period of time greater than or equal to its MTTL, but excluding all Short MTTL. In this manner, an order with a Large MTTL of 8 seconds may be aggressed on by a Medium MTTL order after the Medium MTTL order has been in the book for 8 seconds, but any Short/Small MTTL will be excluded irrespective of the amount of time it remains in the book.

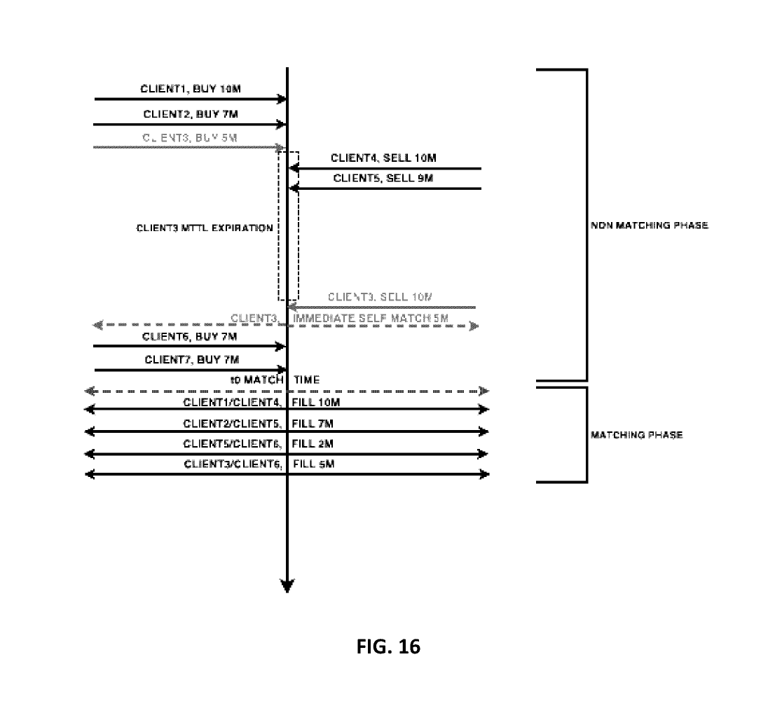

FIG. 16 illustrates an immediate self-match, as described above. In this example, Client 3 submits a buy order of 5M and later submits a sell order of 10M. Upon expiration of Client 3's MTTL, Client 3's buy and sell orders are immediately matched prior to beginning of the standard matching phase, regardless of any queue placement of the first order. Client 3's remaining 5M sell order remains in the book and is later matched according to the prioritization and matching techniques described herein.

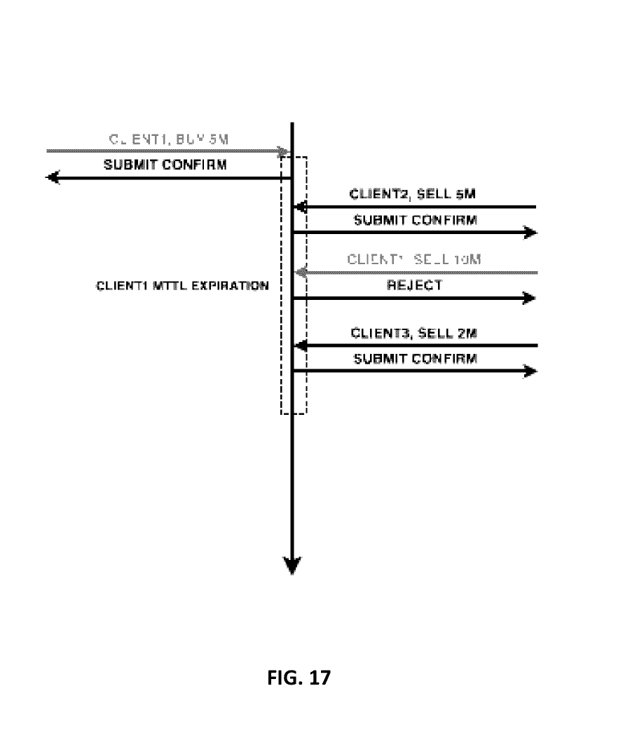

FIG. 17 illustrates an order flow in which Client 1 submits a buy order of 5M and a sell order of 10M, however, the sell order comes before expiration of Client 1's MTTL for the previous buy order. In this case, Client 1's sell order may be rejected entirely, even though it is a different size than the first order, i.e., the entire 10M sell order will be canceled in the example. In this manner, no balance is retained on the canceled order.

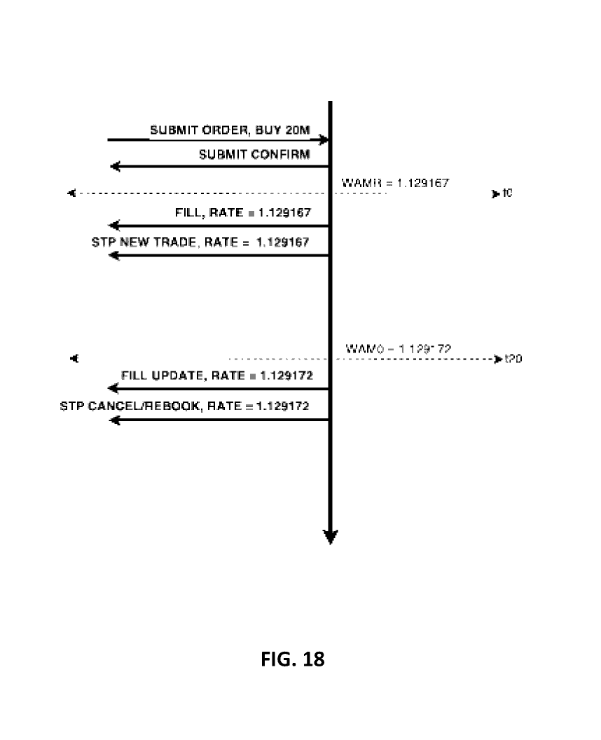

FIG. 18 illustrates an order flow in which a WAMR initial rate is calculated at t0, initial confirmations are provided to the client and STP agents, and a WAMO rate is calculated at t20, with final confirmations provided to the client and STP agents after t20.

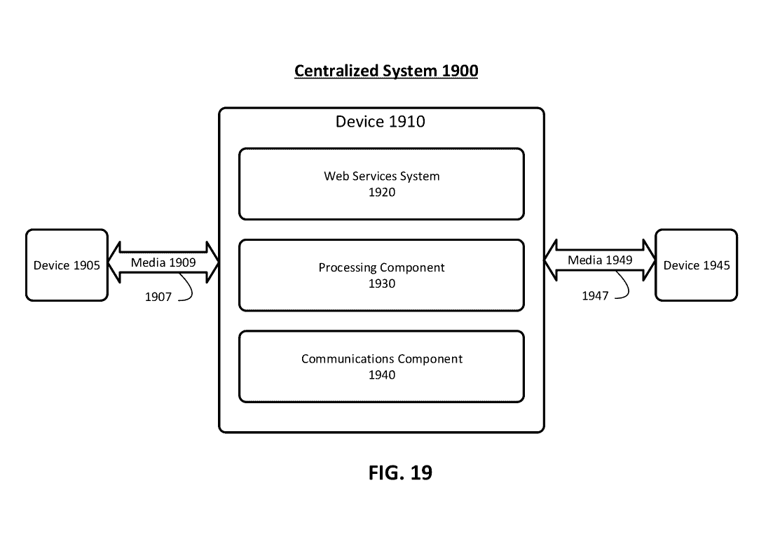

FIG. 19 illustrates a block diagram of a centralized system 1900. The centralized system 1900 may implement some or all of the structure and/or operations for the web services system 1920 in a single computing entity, such as entirely within a single device 1910.

The device 1910 may comprise any electronic device capable of receiving, processing, and sending information for the web services system 1920. Examples of an electronic device may include without limitation a computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 1910 may execute processing operations or logic for the web services system 1920 using a processing component 1930. The processing component 1930 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1910 may execute communications operations or logic for the web services system 1920 using communications component 1940. The communications component 1940 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1909, 1949 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1910 may communicate with other devices 1905, 1945 over a communications media 1909, 1949, respectively, using communications signals 1907, 1947, respectively, via the communications component 1940. The devices 1905, 1945, may be internal or external to the device 1910 as desired for a given implementation. Examples of devices 1905, 1945 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 1905 may correspond to a client device such as a phone used by a user. Signals 1907 sent over media 1909 may therefore comprise communication between the phone and the web services system 1920 in which the phone transmits a request and receives a web page in response.

Device 1945 may correspond to a second user device used by a different user from the first user, described above. In one embodiment, device 1945 may submit information to the web services system 1920 using signals 1947 sent over media 1949 to construct an invitation to the first user to join the services offered by web services system 1920. For example, if web services system 1920 comprises a social networking service, the information sent as signals 1947 may include a name and contact information for the first user, the contact information including phone number or other information used later by the web services system 1920 to recognize an incoming request from the user. In other embodiments, device 1945 may correspond to a device used by a different user that is a friend of the first user on a social networking service, the signals 1947 including status information, news, images, or other social-networking information that is eventually transmitted to device 1905 for viewing by the first user as part of the social networking functionality of the web services system 1920.

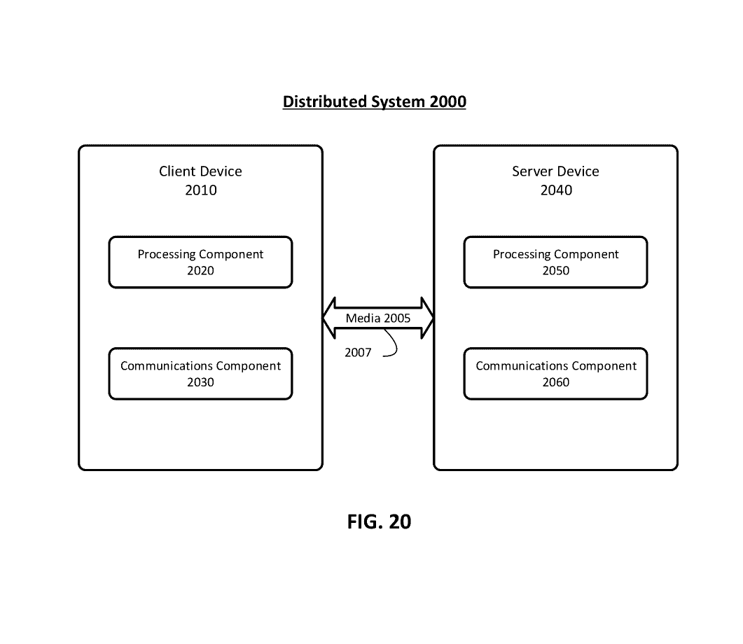

FIG. 20 illustrates a block diagram of a distributed system 2000. The distributed system 2000 may distribute portions of the structure and/or operations for the disclosed embodiments across multiple computing entities. Examples of distributed system 2000 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 2000 may comprise a client device 2010 and a server device 2040. In general, the client device 2010 and the server device 2040 may be the same or similar to device 1910 as described with reference to FIG. 19. For instance, the client device 2010 and the server device 2040 may each comprise a processing component 2020, 2050 and a communications component 2030, 2060 which are the same or similar to the processing component 1930 and the communications component 1940, respectively, as described with reference to FIG. 19. In another example, the devices 2010 and 2040 may communicate over a communications media 2005 using media 2005 via signals 2007.

The client device 2010 may comprise or employ one or more client programs that operate to perform various methodologies in accordance with the described embodiments. In one embodiment, for example, the client device 2010 may implement some steps described with respect client devices described in the preceding figures.

The server device 2040 may comprise or employ one or more server programs that operate to perform various methodologies in accordance with the described embodiments. In one embodiment, for example, the server device 2040 may implement some steps described with respect to server devices described in the preceding figures

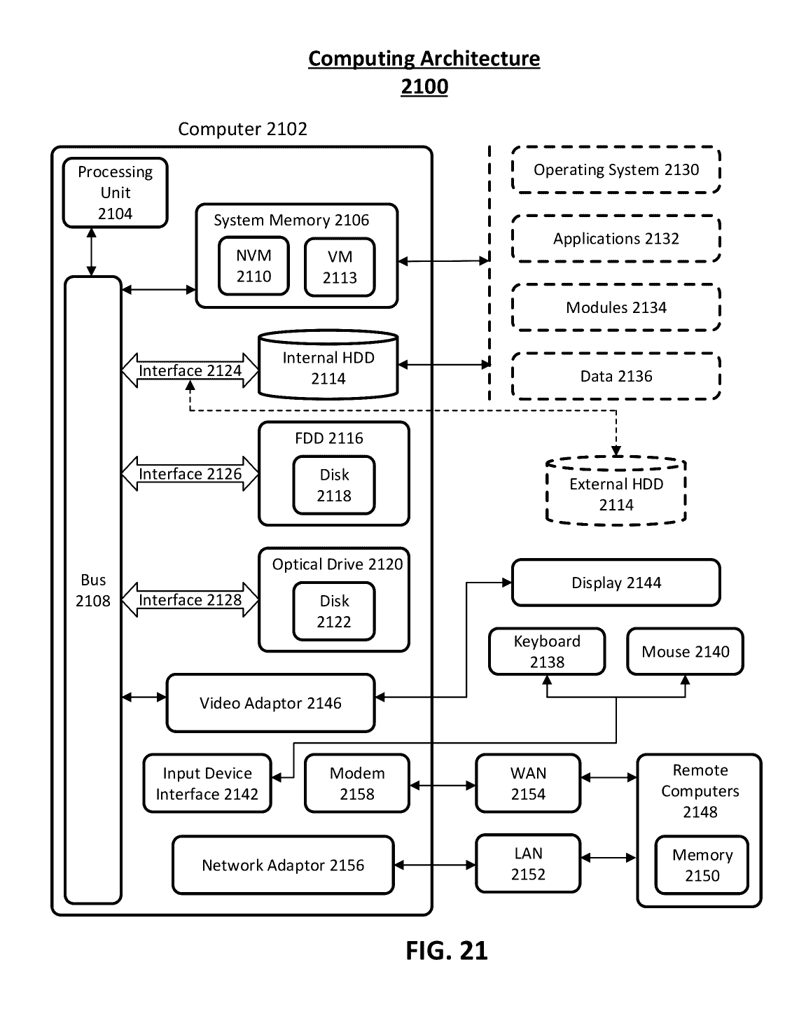

FIG. 21 illustrates an embodiment of an exemplary computing architecture 2100 suitable for implementing various embodiments as previously described. In one embodiment, the computing architecture 2100 may comprise or be implemented as part of an electronic device. Examples of an electronic device may include those described herein. The embodiments are not limited in this context.

As used in this application, the terms “system” and “component” are intended to refer to a computer-related entity, either hardware, a combination of hardware and software, software, or software in execution, examples of which are provided by the exemplary computing architecture 2100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 2100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 21, the computing architecture 2100 comprises a processing unit 2104, a system memory 2106 and a system bus 2108. The processing unit 2104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 2104.

The system bus 2108 provides an interface for system components including, but not limited to, the system memory 2106 to the processing unit 2104. The system bus 2108 can be any of several types of bus structure that may further interconnect to a memory bus (with or without a memory controller), a peripheral bus, and a local bus using any of a variety of commercially available bus architectures. Interface adapters may connect to the system bus 2108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 2100 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2106 may include various types of computer-readable storage media in the form of one or more higher speed memory units, such as read-only memory (ROM), random-access memory (RAM), dynamic RAM (DRAM), Double-Data-Rate DRAM (DDRAIVI), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 21, the system memory 2106 can include non-volatile memory 2110 and/or volatile memory 2113. A basic input/output system (BIOS) can be stored in the non-volatile memory 2110.

The computer 2102 may include various types of computer-readable storage media in the form of one or more lower speed memory units, including an internal (or external) hard disk drive (HDD) 2114, a magnetic floppy disk drive (FDD) 2116 to read from or write to a removable magnetic disk 2118, and an optical disk drive 2120 to read from or write to a removable optical disk 2122 (e.g., a CD-ROM, DVD, or Blu-ray). The HDD 2114, FDD 2116 and optical disk drive 2120 can be connected to the system bus 2108 by a HDD interface 2124, an FDD interface 2126 and an optical drive interface 2128, respectively. The HDD interface 2124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 2110, 2113, including an operating system 2130, one or more application programs 2132, other program modules 2134, and program data 2136. In one embodiment, the one or more application programs 2132, other program modules 2134, and program data 2136 can include, for example, the various applications and/or components to implement the disclosed embodiments.

A user can enter commands and information into the computer 2102 through one or more wire/wireless input devices, for example, a keyboard 2138 and a pointing device, such as a mouse 2140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 2104 through an input device interface 2142 that is coupled to the system bus 2108, but can be connected by other interfaces such as a parallel port, IEEE 1394 serial port, a game port, a USB port, an IR interface, and so forth.

A display 2144 is also connected to the system bus 2108 via an interface, such as a video adaptor 2146. The display 2144 may be internal or external to the computer 2102. In addition to the display 2144, a computer typically includes other peripheral output devices, such as speakers, printers, and so forth.

The computer 2102 may operate in a networked environment using logical connections via wire and/or wireless communications to one or more remote computers, such as a remote computer 2148. The remote computer 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wire/wireless connectivity to a local area network (LAN) 2152 and/or larger networks, for example, a wide area network (WAN) 2154. Such LAN and WAN networking environments are commonplace in offices and companies, and facilitate enterprise-wide computer networks, such as intranets, all of which may connect to a global communications network, for example, the Internet.

When used in a LAN networking environment, the computer 2102 is connected to the LAN 2152 through a wire and/or wireless communication network interface or adaptor 2156. The adaptor 2156 can facilitate wire and/or wireless communications to the LAN 2152, which may also include a wireless access point disposed thereon for communicating with the wireless functionality of the adaptor 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wire and/or wireless device, connects to the system bus 2108 via the input device interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

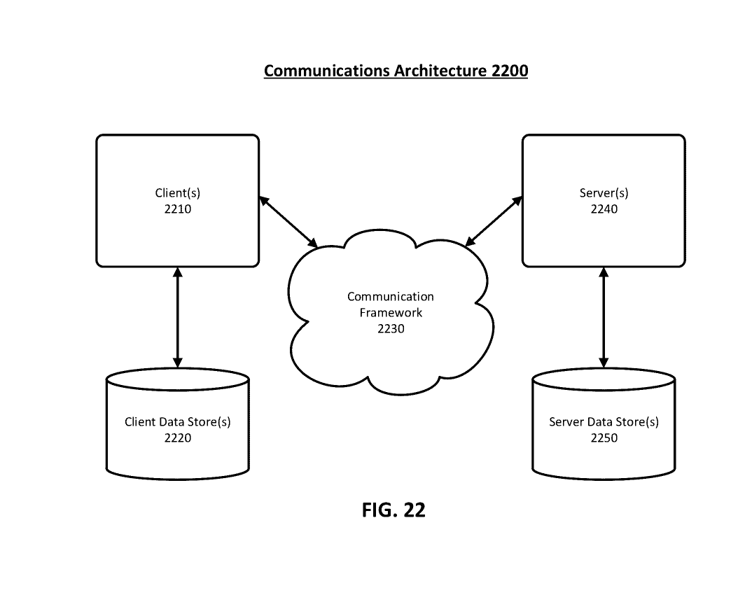

FIG. 22 illustrates a block diagram of an exemplary communications architecture 2200 suitable for implementing various embodiments as previously described. The communications architecture 2200 includes various common communications elements, such as a transmitter, receiver, transceiver, radio, network interface, baseband processor, antenna, amplifiers, filters, power supplies, and so forth. The embodiments, however, are not limited to implementation by the communications architecture 2000.

As shown in FIG. 22, the communications architecture 2200 comprises includes one or more clients 2210 and servers 2240. The clients 2210 may implement the client device 2010, for example. The servers 2240 may implement the server device 2040, for example. The clients 2210 and the servers 2240 are operatively connected to one or more respective client data stores 2220 and server data stores 2250 that can be employed to store information local to the respective clients 2210 and servers 2240, such as cookies and/or associated contextual information.

The clients 2210 and the servers 2240 may communicate information between each other using a communication framework 2230. The communications framework 2230 may implement any well-known communications techniques and protocols. The communications framework 2230 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 2230 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 2210 and the servers 2240. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

1. A computer-implemented method, comprising:
receiving one or more orders at a server, the one or more orders comprising orders to buy or sell currency and including an order size and a minimum time to live (MTTL);
organize the one or more orders into buckets based upon respective order sizes and MTTLs;
prioritize the one or more orders primarily based upon an order size and secondarily based upon MTTL; and
match the one or more orders based upon determined priority to create a matched trade.

2. The computer-implemented method of claim 1, further comprising:
determining whether the one or more orders are of a first order type, a second order type, or a third order type; and
configuring the matching based upon the determine order type.

3. The computer-implemented method of claim 2, wherein the first order type is configured to match at an initial rate at a time t0.

4. The computer-implemented method of claim 2, wherein the second order type is configured to match at an initial rate at a first time, time t0, and the computer-implemented method further comprises:
determining a final rate to the matched trade at a second time, the final rate comprising an average of a plurality of samples taken between the first time and the second time; and
assigning the final rate to the matched trade.

5. The computer-implemented method of claim 2, wherein the third order type is configured to match in two or more liquidity pools and the server is configured to confirm that matching processes within a second liquidity pool are canceled prior to confirming a matched trade in a first liquidity pool.

6. The computer-implemented method of claim 4, wherein the average of a plurality of samples is an average of two or more real-time WAMR rates taken in randomized intervals.

7. A system, comprising:
A server configured to receive one or more orders, the one or more orders comprising orders to buy or sell currency and including an order size and a minimum time to live (MTTL); and
a matching engine configured to:
organize the one or more orders into buckets based upon respective order sizes and MTTLs;
prioritize the one or more orders primarily based upon an order size and secondarily based upon MTTL; and
match the one or more orders based upon determined priority to create a matched trade.

8. The system of claim 7, wherein the matching engine is further configured to:
determine whether the one or more orders are of a first order type, a second order type, or a third order type; and
configure the matching based upon the determine order type.

9. The system of claim 8, wherein the first order type is configured to match at an initial rate at a time t0.

10. The system of claim 8, wherein the second order type is configured to match at an initial rate at a first time, time t0, and the matching engine is further configured to:
determine a final rate to the matched trade at a second time, the final rate comprising an average of a plurality of samples taken between the first time and the second time; and
assign the final rate to the matched trade.

11. The system of claim 8, wherein the third order type is configured to match in two or more liquidity pools and the server is configured to confirm that matching processes within a second liquidity pool are canceled prior to confirming a matched trade in a first liquidity pool.

12. The system of claim 10, wherein the average of a plurality of samples is an average of two or more real-time WAMR rates taken in randomized intervals.

13. An article including a computer-readable storage medium including instructions, that, when executed by a processor, perform the computer-implemented method comprising:
receiving one or more orders at a server, the one or more orders comprising orders to buy or sell currency and including an order size and a minimum time to live (MTTL);
organize the one or more orders into buckets based upon respective order sizes and MTTLs;
prioritize the one or more orders primarily based upon an order size and secondarily based upon MTTL; and
match the one or more orders based upon determined priority to create a matched trade.

14. The article of claim 13, further comprising:
determining whether the one or more orders are of a first order type, a second order type, or a third order type; and
configuring the matching based upon the determine order type.

15. The article of claim 14, wherein the first order type is configured to match at an initial rate at a time t0.

16. The article of claim 14, wherein the second order type is configured to match at an initial rate at a first time, time t0, and the computer-implemented method further comprises:
determining a final rate to the matched trade at a second time, the final rate comprising an average of a plurality of samples taken between the first time and the second time; and
assigning the final rate to the matched trade.

17. The article of claim 14, wherein the third order type is configured to match in two or more liquidity pools and the server is configured to confirm that matching processes within a second liquidity pool are canceled prior to confirming a matched trade in a first liquidity pool.

18. The article of claim 16, wherein the average of a plurality of samples is an average of two or more real-time WAMR rates taken in randomized intervals.
